(19) United States
(12) Patent Application Publication
(10) Pub. No.: US 2016/0170842 A1
(43) Pub. Date: Jun. 16, 2016

(54) WRITING TO FILES AND FILE META-DATA

(71) Applicant: HEWLETT-PACKARD DEVELOPMENT COMPANY, L.P., Houston, TX (US)

(72) Inventor: ANTON AJAY MENDEZ, Bangalore (IN)

(73) Assignee: Hewlett-Packard Development Company, L.P., Houston, TX (US)

(21) Appl. No.: 14/908,119

(22) PCT Filed: Jul. 29, 2013
(86) PCT No.: PCT/IN2013/000472

§ 371 Date: Jan. 27, 2016

(51) Int. Cl. G06F 11/14; G06F 17/30

(52) U.S. Cl. CPC G06F 11/1469; G06F 17/30377; G06F 17/30144; G06F 17/30088; G06F 2201/84

(57) ABSTRACT

Disclosed herein are a system, non-transitory computer-readable medium and method for writing to a file. It is determined whether a file was written to before a failure. Meta-data associated with the file is rolled back or undone to reflect a status of the file before the write.

### BACKGROUND

Writing data to a file may require multiple write operations. In a journaling file system, these multiple operations may be logged in a journal. In the event of a system failure, the files may be left in an invalid intermediate state. The changes logged in the journals may be used to undo changes recorded in the journals until the files are returned to a valid state.

### BRIEF DESCRIPTION OF THE DRAWINGS

FIG. 1 is a block diagram of an example system in accordance with aspects of the present disclosure.

FIG. 2 is a flow diagram of an example method in accordance with aspects of the present disclosure.

FIG. 3 is a working example in accordance with aspects of the present disclosure.

FIG. 4 is a further working example in accordance with aspects of the present disclosure.

### DETAILED DESCRIPTION

As noted above, writing to a file may require multiple write operations. These operations may include writes to meta-data associated with the file. Such meta-data may include a data structure that reflects the file's state at any given time (e.g., file size). During a file update, meta-data may be changed in persistent storage to reflect the status of its associated file when the write is complete. A write may be deemed complete or committed when the data is stored in persistent storage (e.g., hard disk) from volatile storage (e.g., random access memory). Journaling file systems may record the commitment of a write to persistent storage. If a failure occurs, the journal file may be analyzed during recovery to detect write transactions without a commit record. Given that a failure may cause uncommitted data to be lost, any intermediate changes to the file may be rolled back.

Unfortunately, meta-data associated with a file may be committed to persistent storage before commitment of the actual data. As such, if a failure occurs after commitment of the meta-data but before commitment of the data, the meta-data would reflect a commit of a write that never took place. By way of example, a file may contain 100 kilobytes of data in persistent storage and a write transaction may intend to write another 100 kilobytes thereto. The meta-data may be changed to reflect a file size of 200 kilobytes and this change may be committed to persistent storage. At this time, the system may fail and the additional 100 kilobytes of data may be lost (i.e., the data was never written to persistent storage). In this example, the meta-data in persistent storage erroneously reflects a file size of 200 kilobytes. This discrepancy may cause the system to increase the file size in persistent storage to 200 kilobytes. However, the extra 100 kilobytes added to the file would be some random or otherwise arbitrary data.

In view of the foregoing, disclosed herein are a system, computer-readable medium, and method for file recovery. In one example, it may be determined whether a file was written to before a failure. In another example, if the write failed and its meta-data reflects commitment of the write, meta-data associated with the file may be rolled back or undone to reflect a status of the file before the write. Thus, the techniques disclosed herein may prevent the writing of arbitrary or random data to files caused by a disparity between the meta-data and the actual state of the file. Instead, changes to the meta-data may be undone so that it reflects the correct state of the file. The aspects, features and advantages of the present disclosure will be appreciated when considered with reference to the following description of examples and accompanying figures. The following description does not limit the application; rather, the scope of the disclosure is defined by the appended claims and equivalents.

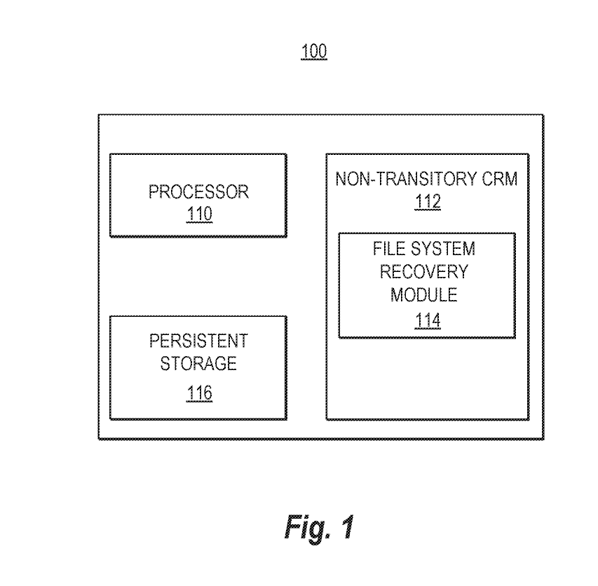

FIG. 1 presents a schematic diagram of an illustrative computer apparatus 100 for executing the techniques disclosed herein. Computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other computers over a network. The computer apparatus 100 may also contain a processor 110, which may be any number of well known processors, such as processors from Intel® Corporation. In another example, processor 110 may be an application specific integrated circuit (“ASIC”). Non-transitory computer readable medium (“CRM”) 112 may store instructions that may be retrieved and executed by processor 110. As will be discussed in more detail below, the instructions may include file system recovery module 114.

Computer apparatus 100 may also comprise a persistent storage device 116 that allows information to be retrieved, manipulated, and stored by processor 110. Data stored in persistent storage device 116 may remain despite a failure or a power outage. Some examples of a persistent storage device 116 may include, but are not limited to, a disk drive, a fixed or removable magnetic media drive (e.g., hard drives, floppy or zip-based drives), a writable or read-only optical media drive (e.g., CD or DVD), a tape drive, or a solid-state mass storage device. Alternatively, persistent storage device 116 may be a memristor device, a phase change memory (“PCM”) device, spin-torque transfer RAM (“STT-RAM”), flash memory, or battery backed DRAM. In one example, persistent storage device 116 may be in a location physically remote from, yet still accessible by, processor 110. In another example, data may be distributed across multiple networked storage devices.

Non-transitory CRM 112 may be used by or in connection with any instruction execution system that can fetch or obtain the logic from non-transitory CRM 112 and execute the instructions contained therein. Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. Alternatively, non-transitory CRM 112 may be a random access memory (“RAM”) device or may be divided into multiple memory segments organized as dual in-line memory modules (“DIMMs”). The non-transitory CRM 112 may also include any combination of one or more of the foregoing and/or other devices as well. While only one processor and one non-transitory CRM are shown in FIG. 1, computer apparatus 100 may actually comprise additional processors and memories that may or may not be stored within the same physical housing or location.

The instructions residing in non-transitory CRM 112 may comprise any set of instructions to be executed directly (such as machine code) or indirectly (such as scripts) by processor 110. In this regard, the terms “instructions,” “scripts,” and “applications” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative. In a further example, the instructions may be registered to a journaling subsystem responsible for recording event data of the file system. The instructions may utilize an application programming interface (“API”) that permits communication and access to the journaling subsystem.

In one example, file system recovery module 114 may instruct processor 110 to recover from a failure of the file system. In another example, file system recovery module 114 may instruct processor 110 to determine whether a write was not committed to a file in persistent storage before a system failure. In a further example, file system recovery module 114 may instruct processor 110 to determine whether meta-data associated with the file erroneously reflects a commit of the write to the file. In yet a further example, file system recovery module 114 may instruct processor 110 to rollback the meta-data such that the meta-data reflects a status of the file without commitment of the write, If the write was not committed and the meta-data erroneously reflects commitment of the write.

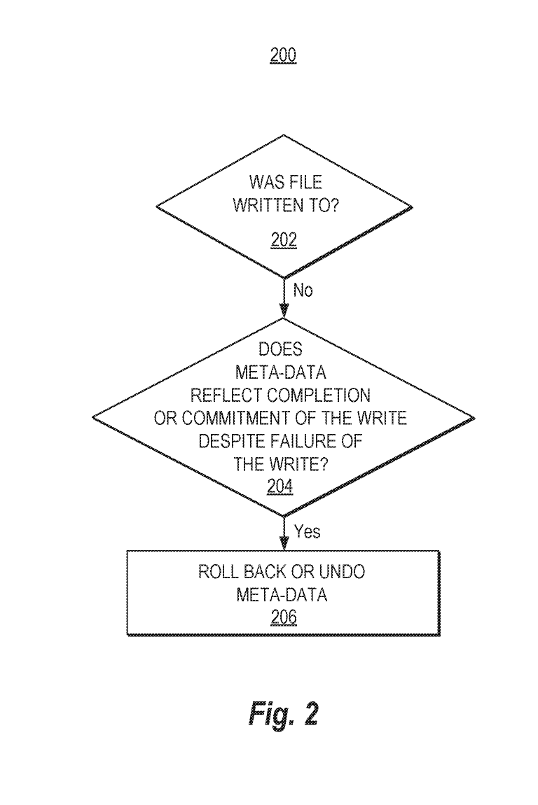

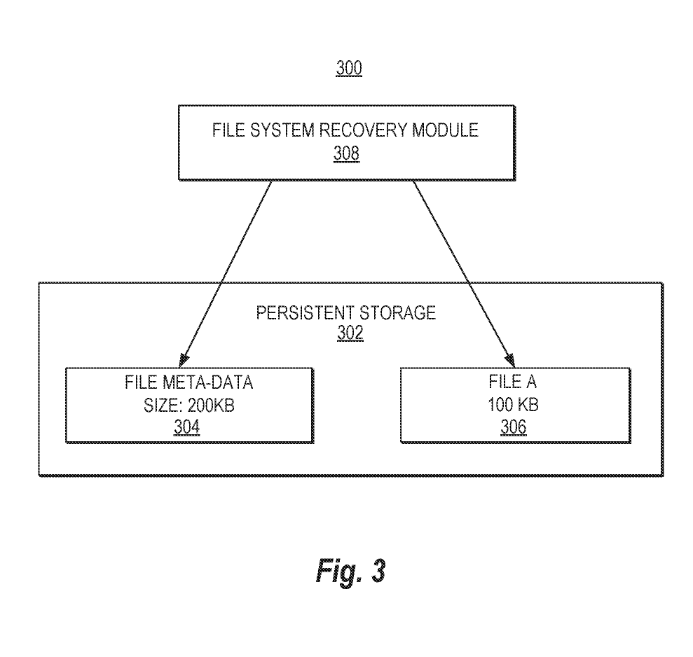

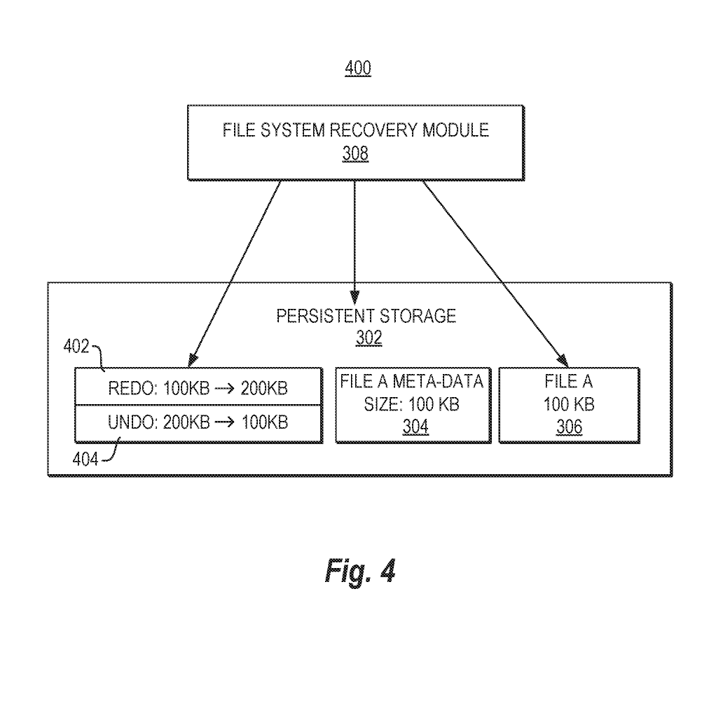

Working examples of the system, method, and non-transitory computer-readable medium are shown in FIGS. 2-4. In particular, FIG. 2 illustrates a flow diagram of an example method 200 for file recovery. FIGS. 3-4 each show a working example in accordance with the techniques disclosed herein. The actions shown in FIGS. 3-4 will be discussed below with regard to the flow diagram of FIG. 2.

As shown in block 202 of FIG. 2, it may be determined whether a write to a file was successful or whether the write was interrupted by a failure. In one example, this determination may be made by determining whether a commit record for the data exists in the journal file. Such commit record may indicate that the data was stored in persistent storage. Referring back to FIG. 2, if the write was not successful, it may be determined whether meta-data associated with the file reflects a completion or commitment of the write, as shown in block 204.

Referring now to FIG. 3, file system recovery module 308 is shown detecting the status of file 306 and its associated meta-data 304. In one example, meta-data 304 may include an index node (“mode”) data structure that contains information pertaining to file 306 such as, but not limited to, file size, location, device driver interface, or socket information. In the example of FIG. 3, meta-data 304 indicates that file 306 is 200 kilobytes; however, the actual size of file 306 is 100 kilobytes. File system recovery module 308 may become aware of this discrepancy by discovering that a commit of the 100 kilobytes to persistent storage was never recorded and that the meta-data in persistent storage indicates a size of 200 kilobytes.

In one example, file system recovery module 308 may discover discrepancies between meta-data and its associated file by recording changes to the meta-data and comparing these recorded meta-data changes to those of its associated file. For example, file system recovery module 308 may discover that meta-data 304 reflects commitment of the 100 kilobytes by recording the update to meta-data 304 that changed the file size to 200 kilobytes. In a further example, when a new write transaction begins, file system recovery module 308 may generate a redo journal record comprising modifications to the meta-data that reflect commitment of the write. In another example, file system recovery module 308 may also generate an undo journal record comprising meta-data that reflects the status of the file before commitment of the write and may also associate the undo journal record with the redo journal record. File system recovery module 308 may verify that the meta-data is consistent with its associated file by reading and analyzing these records after a failure. As will be discussed further below, these records may also be used to undo the meta-data if a discrepancy between the meta-data and its associated file is detected,

In a further example, each write request may be committed in an order in which each write request is received. The write transactions may be placed, for example, in a queue and processed on a first-in-first-out (“FIFO”) basis. Each write transaction may be mapped to data cached in volatile memory. The write transaction may be dequeued and a data commit record may be logged in the journal, when the data is moved from volatile memory to persistent storage.

Referring back to FIG. 2, if the meta-data reflects commitment of the write despite a failure of the write, the meta-data may be rolled back, as shown in block 206. Referring now to FIG. 4, file system recovery module 308 is shown rolling back meta-data 304 using redo journal record 402 and its associated undo journal record 404. Journal records 402 and 404 may have been recorded in the journal when meta-data 304 was changed to reflect a file size of 200 kilobytes from 100 kilobytes. Although the 100 kilobytes intended for file 306 was lost due to the failure, file system recovery module 308 may revert the meta-data back to its status before the write to make the meta-data consistent with its associated file. While the examples herein compare the file size meta-data to the actual file size, it is understood that the techniques herein may be used to compare any attribute of the meta-data with the actual attributes of the file such as, for example, the location of the file, the device driver interface, or socket information. As such, in addition to the file size, a write transaction as used herein may also include changes to any attribute of the file. File system recovery module 308 may ensure that these other attributes of the meta-data and its associated file remain consistent after a failure.

Advantageously, the foregoing system, method, and non-transitory computer readable medium may ensure that meta-data remains consistent with its associated file despite a failure of the system. In this regard, a before and after snapshot of the meta-data may be logged in a journal file via redo and undo records. In turn, users may be rest assured that their systems will be returned to a consistent state after an unexpected failure or power outage.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A file system comprising:
a persistent storage;
a file system recovery module which, if executed, instructs at least one processor to:
recover from a failure of the file system;
determine whether a write was not committed to a file in the persistent storage before the failure;
determine whether meta-data associated with the file erroneously reflects a commit of the write to the file; and
If the write was not committed and the meta-data erroneously reflects commitment of the write, rollback the meta-data such that the meta-data reflects a status of the file without commitment of the write.

2. The file system of claim 1, wherein the file system recovery module, if executed, further instructs at least one processor to generate a redo journal record comprising modifications to the meta-data that reflect commitment of the write.

3. The file system of claim 2, wherein the file system recovery module, if executed, further instructs at least one processor to generate an undo journal record comprising a status of the meta-data before commitment of the write and to associate the undo journal record with the redo journal record.

4. The file system of claim 3, wherein the file system recovery module, if executed, further instructs at least one processor to rollback the meta-data using the undo journal record and the redo journal record associated therewith.

5. The file system of claim 1, wherein each write request is committed in an order in which each write request is received.

6. A non-transitory computer readable medium having instructions therein which, if executed, cause at least one processor to:
determine whether a write transaction to a file was unsuccessful;
determine whether meta-data associated with the file reflects successful completion of the write transaction; and
If the write transaction was unsuccessful and the meta-data reflects successful completion of the write, undo the meta-data such that the meta-data reflects a status of the file without completion of the write transaction.

7. The non-transitory computer readable medium of claim 6, wherein the instructions therein, if executed, further cause at least one processor to generate a redo journal record comprising modifications made to the meta-data that reflect completion of the write transaction.

8. The non-transitory computer readable medium of claim 7, wherein the instructions therein, if executed, further cause at least one processor to generate an undo journal record comprising a status of the meta-data before the write was attempted and associating the undo journal record with the redo journal record.

9. The non-transitory computer readable medium of claim 8, wherein the instructions therein, if executed, further cause at least one processor to rollback the meta-data using the undo journal record and the redo journal record associated therewith.

10. The non-transitory computer readable medium of claim 6, wherein each write transaction is completed in an order in which each write transaction is received.

11. A method comprising:
determining, using at least one processor, whether a write transaction to a file was interrupted due to a failure;
determining, using at least one processor, whether meta-data associated with the file was updated before the failure such that the meta-data reflects completion of the write transaction to the file; and
If the write transaction was interrupted and the meta-data reflects completion of the write transaction, undoing, using at least one processor, the meta-data such that the meta-data reflects a status of the file before the write transaction was attempted.

12. The method of claim 11 further comprising logging, using at least one processor, a redo journal record comprising modifications made to the meta-data that reflect completion of the write transaction.

13. The method of claim 12 further comprising:
logging, using at least one processor, an undo journal record comprising a status of the meta-data associated with the file before attempt of the write transaction; and
associating, using at least one processor, the undo journal record with the redo journal record.

14. The method of claim 13 further comprising undoing, using at least one processor, the meta-data with the undo journal record and the redo journal record associated therewith.

15. The method of claim 11, further comprising executing, using at least one processor, each write request in an order in which each write request is received.
